(19) United States
(12) Patent Application Publication
(10) Pub. No.: US 2010/0309309 A1
(43) Pub. Date: Dec. 9, 2010

(54) METHOD FOR PRECISELY DETECTING CRACK WIDTH

(75) Inventor: Luo Bing, Shennanzhonglu (CN)

Correspondence Address: DOVAS LAW P.C., 307 BAINBRIDGE STREET, PHILADELPHIA, PA, 19147, US

(73) Assignee: SHENZHEN SIWEIER DETECTING TECHNOLOGY LTD., Shennanzhonglu (CN)

(21) Appl. No.: 12/479,270

(22) Filed: Jun. 5, 2009

(51) Int. Cl. H04N 7/18

(52) U.S. Cl. 348/128; 348/E07.085

(57) ABSTRACT

A method for precisely detecting a width of a crack on a surface of an object is provided. The method includes positioning a crack width observation apparatus on the object, turning on a first light source at a first side of the crack, and photographing the surface with the first light source on to generate a first photograph to determine a boundary of the crack at the side distanced closest to the light source. A second light source at a second side of the crack is turned on to irradiate the surface of the object, and the surface is photographed with the second light source on to generate a second photograph to determine a boundary of the crack at the second side. The first photograph and the second photograph are processed to obtain a picture showing an actual boundary of the crack.

### FIELD OF INVENTION

The present invention relates to a method for detecting cracks in concrete, buildings and installations, and more particularly to a method of performing precise detection and calculation of cracks.

### BACKGROUND

Cracks may occur in buildings due to various causes in concrete structures, bridges, roads and installations, and may lead to severe accidents on bridges, highways and installations. Accordingly, high safety coefficients are specified, and cracks are periodically observed and monitored, and repairs are made in a timely manner when limits defined by safety coefficients are exceeded.

Crack width observation apparatuses are conventionally used in determining the extent of structural cracks. There are many types of crack width observation apparatuses currently available on the market. Main components of these products typically consist of light sources, microscopic imaging lenses, micro image pickups and electronic image display screens. The principle of such apparatuses is to irradiate with the light source the surface of a detected object containing a crack, wherein the image is displayed in the color black when there is no light at the crack, and the width of the crack can be obtained by measuring the width of the black portion.

One or more light sources, typically including an LED lamp, are mounted on either side of the image pickup of such apparatus to respectively irradiate either side of the crack on the surface of the object under detection. A certain level of brightness is required of the light source in order that the surface of the object under detection can be clearly seen on the display screen. Photographing is then performed. The black portion in the photograph or image is a crack, and the width of the crack can be determined by measuring the width of this black portion.

However, during the irradiating process using the light source, the sidewall of the crack at the side closer to the light source will be irradiated by partial light, so that the boundary shown on the photographed two-dimensional electronic image is too blurry to be clearly discerned, and the protruding portion on the sidewall of the crack is also displayed on the two-dimensional electronic image, thus being mistakenly regarded as the surface of the object. Such a measuring mode makes the width of the black portion in the image smaller than the actual width of the crack, and it is impossible to precisely measure the actual width of the crack. With increases in crack width, measurements using known apparatuses are more influenced by object reflectivity, and objects having higher reflectivity may be subject to even greater measurement errors. Such deficiencies in known crack measurement apparatuses affect the ability to safely maintain building structures.

### SUMMARY

In view of the above, the objective of the present invention is to provide a method for precisely measuring a crack width. The method makes it possible to precisely determine the boundaries at both sides of a crack, so that the calculation result exactly reflects the actual width of the crack, to thereby provide a reliable basis to monitor the crack. Another objective of the present invention is to provide a simple method for detecting a crack width, whereby the crack is irradiated in more than one step to precisely display the boundary of the crack, thereby permitting precise measurement and calculation of the crack.

The concept of the present invention is described as follows. When only one of two light sources of a crack width observation apparatus emits light, the boundary of the crack at the side in the image distanced closer to the light source is clear and realistic, whereas the boundary at the other side is blurry because the light irradiates the sidewall and it is impossible to exactly determine the position of the boundary. By a preferred embodiment of the present invention, the boundary of the crack at one side is firstly determined, the boundary of the crack at another side is subsequently determined, and the results are combined to determine the precise width of the crack.

Accordingly, implementation of the present invention comprises the following steps:

1. positioning a crack width observation apparatus;

2. turning on a light source at one side of a crack to irradiate a surface of an object under detection containing the crack, and photographing the same to determine a boundary of the crack at the side distanced closer to the light source;

3. subsequently turning on a light source at another side of the crack to irradiate a surface of an object under detection containing the crack, and photographing the same to determine a boundary of the crack at the other side thereof; and

4. processing the photographed two pictures to obtain a clear picture showing an actual boundary of the crack.

The boundaries of the crack can be clearly discerned in the generated pictures, and the width of the crack can be obtained by calculating or by calibration-measuring the crack boundaries in the pictures. This method removes the adverse influence of illumination by the light sources on the crack boundaries, substantially avoids the problem of erroneously small measurements resulting from reflection off of the surface of the crack sidewall, and precisely indicates the actual width of the crack.

Since it is necessary to photograph twice, it is important that the lens of the crack width observation apparatus is first fixedly positioned. The positioning can be performed in a manner that the probe lens of the crack width observation apparatus is fixedly held by hand to photograph, or in a manner that a fixing mechanism is further provided on the probe lens of the crack width observation apparatus.

One feasible mode is to provide a front portion of the probe lens of the crack width observation apparatus with a face-shaped contact surface to increase the area of contact with the object to be detected to avoid inadvertent misalignment through an increase in static frictional force. It is also possible to provide a plastic rubber or a rubber washer on the contact surface to further enhance the fixing effect. Various alternative fixing modes may be employed, as it is also possible to employ such modes as locking, etc.

The time interval between the photographing in step 2 above and the photographing in step 3 above is preferably minimized to be as short as possible. The light source used in step 2 above is immediately turned off after the photographing in step 2 is finished, and the light source at the other side is simultaneously turned on to perform the photographing in step 3.

Since the probe lens of the crack width observation apparatus is statically positioned, the photographed pictures are taken based on the same position, so that the coordinates of the cracks shown in the pictures are consistent with each other. The left side boundary of the crack is extracted from the picture taken while the light source at the left side is used to illuminate, and the right side boundary of the crack is extracted from the picture taken while the light source at the right side is used to illuminate. The boundaries at the two sides are synthesized by digital image processing technology to form a precise boundary graph of the crack, and the precise size of the crack can be obtained by measuring the actual interval between the crack boundaries.

With regard to the photographed picture showing the actual boundary of the crack, the crack in the picture can be partially segmented to remove inexact crack boundaries and retain only exact crack boundaries. The two segmented pictures are then spliced, wherein the spliced two crack boundaries are the actual boundaries of the crack.

The method of segmenting the picture can be carried out by segmenting along a central line of the crack, or by segmenting only inexact portions of the crack, wherein a segmenting line of a following picture should be consistent with a segmenting line of the previous picture.

For the illumination light sources, two illumination lamps are preferably arranged at each side of the crack or the probe lens. However, considering the influence of the effect of divergence of the light, it is preferable to arrange several illumination lamps alongside each other at each side of the crack, so as to provide the light with the effect of parallel illumination, and to lower the demand on the brightness of the illumination light sources to avoid distortion of the pictures due to light intensity.

The aforementioned steps 2 and 3 can be repeated more than once in order to more precisely acquire the photographed pictures, or to photograph a plurality of differently located cracks.

The present invention employs the method of photographing twice and selecting precise crack boundaries to discard inexact crack boundaries and select exact crack boundaries. This avoids the problem of imprecise crack boundaries caused by photographing once, greatly enhancing the precision of crack detection, thereby providing reliable data during inspection of concrete structures, buildings and installations.

### BRIEF DESCRIPTION OF THE DRAWING(S)

The foregoing Summary as well as the following detailed description will be readily understood in conjunction with the appended drawings which illustrate preferred embodiments of the invention. In the drawings:

FIG. 1 is a view exemplarily showing a picture taken of a crack for a first time according to the present invention;

FIG. 2 is a view exemplarily showing a picture taken of the crack for a second time according to a preferred embodiment of the present invention;

FIG. 3 is a view showing a display of the crack measured by the prior art method;

FIG. 4 is a view showing a display of the crack photographed for a first time by the method according to the present invention;

FIG. 5 is a view showing a display of the crack photographed for a second time by the method according to the present invention; and

FIG. 6 is a perspective view showing a crack width observation apparatus installed on a surface according to the present invention.

FIG. 7 is an elevation view showing the crack width observation apparatus installed on the surface of FIG. 6 according to the present invention.

FIG. 8 is a flowchart showing a method for detecting a width of a crack on a surface of an object according to a preferred embodiment of the present invention.

### DETAILED DESCRIPTION OF THE PREFERRED EMBODIMENT(S)

The preferred embodiments of the present invention are described below with reference to the drawing figures where like numerals represent like elements throughout.

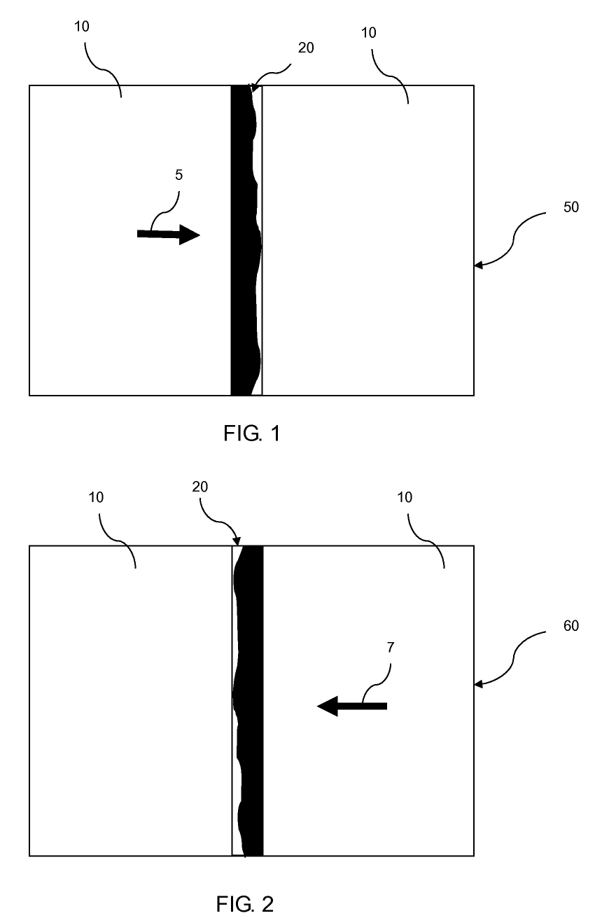

FIGS. 1 and 2 are views showing photographs 50, 60 of concrete cracks having supposed regular boundaries. After a probe lens of the crack width observation apparatus has been fixed, the left side light source (usually an LED lamp) is turned on to emit light, designated by arrow 5, to illuminate from the left side the surface of an object 10 under detection containing a crack 20 to generate the first photograph 50. Since the sidewall of the concrete crack 20 has different components and shapes, and the reflection of the light at each point is different from reflection at another point, the reflection result is as shown in FIG. 1, where each point has errors to differing extents at the crack boundaries far away from the light source.

The light source used during the first photograph is then turned off, and the light source at another side of the crack 20 is simultaneously turned on to emit light, designated by arrow 7, to illuminate from the right side to generate the second photograph 60. Similarly, the sidewall of the concrete crack 20 has different components and shapes, and reflection of the light at each point is different from reflection at another point, and the reflection result is as shown in FIG. 2, where each point has errors to differing extents at the crack boundaries far away from the light source. The time interval between generating the first photograph and the second photograph is preferably minimized to be as short as possible. The light source used during the first photographing is immediately turned off after the first photographing is complete, and the light source at the other side is simultaneously turned on to generate the second photograph.

Thus, the surface of the object 10 under detection containing a crack 20 is electronically photographed twice (imaged twice), and the light source at only one side is allowed to emit light each time a photograph is taken to obtain two pictures, in one of which the picture is segmented according to the central line of the black portion in the picture, and in another one of which the picture is segmented according to the central line of the previous picture. The segmented pictures reflecting the actual boundaries are then spliced together to obtain a realistic crack width graph. Alternatively, the method of segmenting the picture can be carried out by segmenting only inexact portions of the crack, wherein a segmenting line of a following picture should be consistent with a segmenting line of the previous picture.

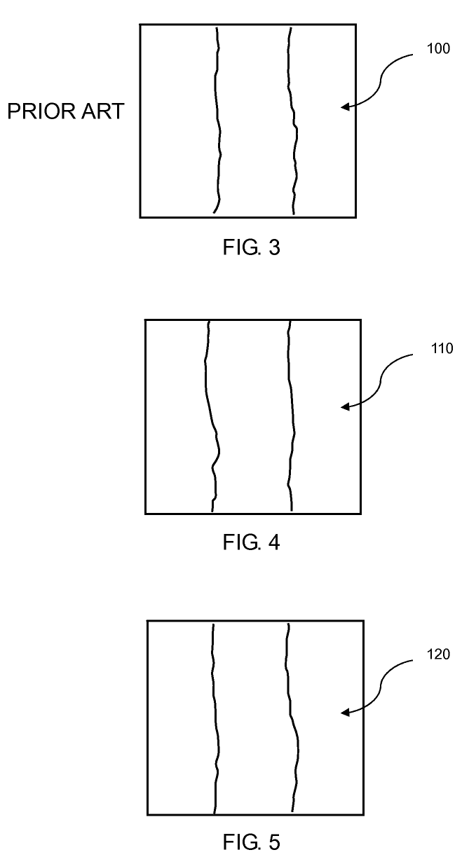

Specific application effects are as shown in FIGS. 3, 4 and 5. FIG. 3 is a view showing an example determined crack 100 of concrete photographed according to the prior art method. As can be calculated from the example of FIG. 3, the maximum width of the crack 100 is 0.861 mm and the average width thereof is 0.785 mm.

To compare with the above result of prior art FIG. 3, the present invention is employed to photograph twice, firstly fixing securely the probe lens of the crack width observation apparatus, so that it is not displaced during the photographing process, subsequently carrying out the first photographing by illuminating from the left side, the picture photographed being as shown in FIG. 4, and then carrying out the second photographing by illuminating from the right side, the picture photographed being as shown in FIG. 5.

As can be seen by merely comparing the boundary lines of the cracks in these Figures, the crack widths in both FIGS. 4 and 5 are greater than the crack width as shown in FIG. 3, and some points in the crack boundary lines in FIG. 3 are expressed in the lines in FIG. 4 or FIG. 5, so it is apparent that the crack boundaries as shown in FIG. 3 are inexact.

The crack boundaries photographed according to FIGS. 4 and 5 are then synthesized, and the calculation result obtained thereby shows the maximum width as 1.037 mm and the average width as 0.967 mm, which differ significantly from the result shown in FIG. 3, indicating that the method employed in FIG. 3 contains significant errors intolerable in the construction of concrete structures, buildings and installations.

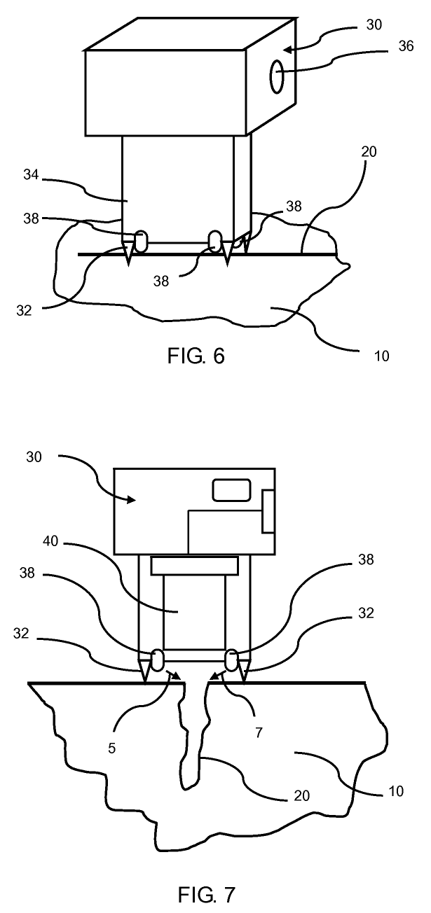

FIG. 6 shows a crack width observation apparatus 30, attached to the object 10 under detection containing the crack 20, suitable for performing the preferred method of the invention. The observation apparatus 30 includes feet 32 on a central portion 34 thereof and a controller 36 configured for operation of lamps 38 and a photographing device 40 preferably including a probe lens connected thereto. The controller 36 is preferably configured to operate the lamps 38 and the photographing device 40 in the manner described above with reference to the preferred method of the invention. Specifically, the controller 36 is preferably configured to turn on a first pair of the lamps 38 comprising a first light source to emit light designated by the arrow 5 and take a picture of the crack 20 with the photographing device 40 with the first light source on. Thereafter, the first pair of lamps 38 is turned off and a second pair of lamps 38 comprising a second light source is turned on to emit light designated by the arrow 7. The controller 36 is further configured to take a picture of the crack 20 with the photographing device 40 with the second light source on. The controller 36 is further configured to process the two photographs to generate a composite view of the crack 20, preferably by segmenting the photographs along a shared central line and splicing together the segmented portions as described above. The controller 36 may alternatively be positioned external to the apparatus 30.

Since it is necessary to photograph twice, it is important that the probe lens of the crack width observation apparatus 30 is first fixedly positioned. The positioning can be performed in a manner that the probe lens of the crack width observation apparatus is fixedly held by hand to photograph, or in a manner that a fixing mechanism is further provided on the probe lens of the crack width observation apparatus.

One feasible mode is to provide a front portion of probe lens of the crack width observation apparatus with a face-shaped contact surface to increase the area of contact with the object to be detected to avoid inadvertent misalignment through an increase in frictional force. It is also possible to provide a plastic rubber or a rubber washer on the contact surface to further enhance the fixing effect. The fixing modes are varied, as it is also possible to employ such modes as locking, etc.

For the illumination light sources, two illumination lamps are usually arranged at both sides of crack width observation apparatus 30. However, considering the influence of the effect of divergence of the light, it is preferable to arrange more than one illumination lamps alongside each other at both sides of the crack, so as to provide the light with the effect of parallel illumination, and to lower the demand on the brightness of the illumination light sources to thereby avoid distortion of the pictures due to light intensity.

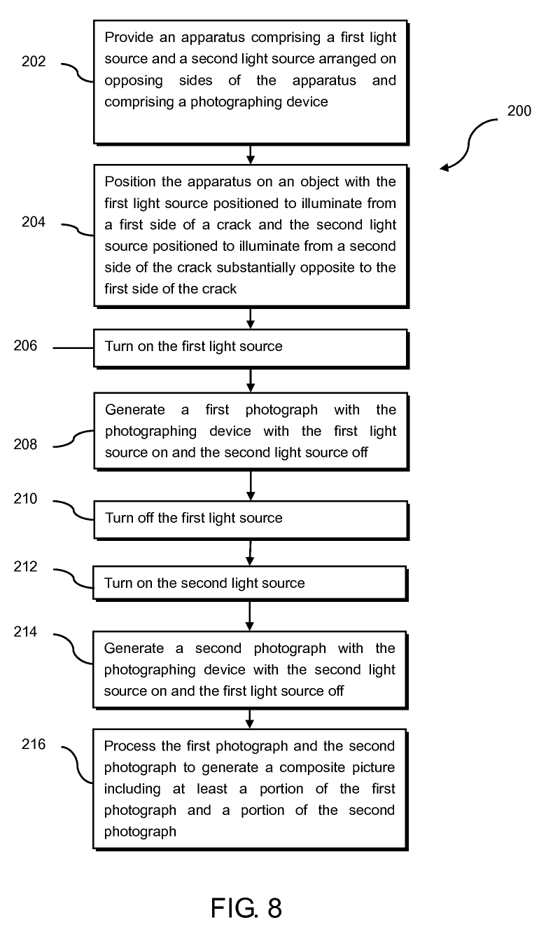

Referring to FIG. 8, a flowchart showing a method 200 for detecting a width of a crack on a surface of an object according to a preferred embodiment of the present invention is provided. The method includes providing an apparatus comprising a first light source and a second light source arranged on opposing sides of the apparatus and comprising a photographing device (step 202). The method further includes positioning the apparatus on the object with the first light source positioned to illuminate from a first side of the crack and the second light source positioned to illuminate from a second side of the crack substantially opposite to the first side of the crack (step 204). The first light source is turned on (step 206). A first photograph is generated with the photographing device with the first light source on and the second light source off (step 208). The first light source is turned off (step 210). The second light source is turned on (step 212). A second photograph is generated with the photographing device with the second light source on and the first light source off (step 214). The first photograph and the second photograph are processed to generate a composite picture including at least a portion of the first photograph and a portion of the second photograph (step 216).

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A method for precisely detecting a width of a crack on a surface of an object comprising:
positioning a crack width observation apparatus on the object;
turning on a first light source at a first side of the crack to irradiate the surface of the object under detection including the crack, and photographing the surface with the first light source on to generate a first photograph to determine a boundary of the crack at the side distanced closest to the light source;
subsequently turning on a second light source at a second side of the crack to irradiate the surface of the object under detection including the crack, and photographing the surface with the second light source on to generate a second photograph to determine a boundary of the crack at the second side; and
processing the first photograph and the second photograph to obtain a picture showing an actual boundary of the crack.

2. The method according to claim 1, further comprising turning off the first light source before generating the second photograph.

3. The method according to claim 1, wherein a time interval between generating the first photograph and generating the second photograph is set to a minimum value and, the first light source is immediately turned off after photographing to generate the first photograph is finished, and the second light source is turned on substantially simultaneously with the turning off of the first light source to generate the second photograph.

4. The method according to claim 1, wherein the photographed actual boundary picture of the crack is partially segmented to remove inexact crack boundaries and only retain exact crack boundaries, and the segmented pictures are then spliced, whereby the spliced two crack boundaries are the actual boundaries of the crack.

5. The method according to claim 4, wherein the method of segmenting the picture is carried out by at least one of segmenting along a central line of the crack and by segmenting only inexact portions of the crack, wherein a segmenting line of the next picture is consistent with a segmenting line of the previous picture.

6. The method according to claim 1, wherein turning on the first light source comprises turning on a plurality of light sources, and turning on the second light source comprises turning on another plurality of light sources.

7. The method according to claim 1, wherein carrying out the step of turning on the first light source and photographing to generate and first photograph and the step of turning on the second light source and photographing to generate the second photograph are performed more than one time.

8. A method for detecting a width of a crack on a surface of an object comprising:
providing an apparatus comprising a first light source and a second light source arranged on opposing sides of the apparatus and a photographing device;
positioning the apparatus on the object with the first light source positioned to illuminate from a first side of the crack and the second light source positioned to illuminate from a second side of the crack substantially opposite to the first side of the crack;
turning on the first light source;
generating a first photograph with the photographing device with the first light source on and the second light source off;
turning off the first light source;
turning on the second light source;
generating a second photograph with the photographing device with the second light source on and the first light source off; and
processing the first photograph and the second photograph to generate a composite picture including at least a portion of the first photograph and a portion of the second photograph.

9. A crack width observation apparatus comprising a first light source and a second light source arranged on opposing sides of the apparatus, a photographing device directed toward an output area of the first light source and the second light source, and a controller configured to:
turn on the first light source;
generate a first photograph with the photographing device with the first light source on and the second light source off;
turn off the first light source;
turn on the second light source;
generate a second photograph with the photographing device with the second light source on and the first light source off; and
process the first photograph and the second photograph to generate a composite picture including at least a portion of the first photograph and a portion of the second photograph.
